(19) United States
(12) Patent Application Publication
(10) Pub. No.: US 2025/0321988 A1
(43) Pub. Date: Oct. 16, 2025

(54) SYSTEMS AND METHODS FOR GENERATING TRANSFER MESSAGES BASED ON UNSTRUCTURED DATA

(71) Applicant: The Toronto-Dominion Bank, Toronto (CA)

(72) Inventors: Hitesh BAJAJ, Duluth, GA (US); Milos DUNJIC, Oakville (CA); David Samuel TAX, Toronto (CA); Jonathan Joseph PRENDERGAST, West Chester, PA (US); Mohit SHARMA, Toronto (CA); Thomas Osman KELLY, Wenonah, NJ (US); Pranay Chander GUPTA, Toronto (CA); Kushank RASTOGI, Toronto (CA); Abhijit SINGHA HAZARI, Oakville (CA)

(73) Assignee: The Toronto-Dominion Bank, Toronto (CA)

(21) Appl. No.: 18/633,777

(22) Filed: Apr. 12, 2024

(51) Int. Cl. G06F 16/332; G06F 40/30; G10L 13/08

(52) U.S. Cl. CPC G06F 16/3329; G06F 40/30; G10L 13/08

(57) ABSTRACT

Systems and methods for sending a transfer message based on unstructured text data are disclosed. A method may receive unstructured text data associated with an account, and based on the unstructured text data, identify an intent to transfer data. The unstructured text data may then be sent to a Large Language Model (LLM) via a first prompt engine and an LLM Application Programming Interface (API). First LLM output data may then be received form the LLM, and the transfer message may be sent based on the first LLM output data. The LLM may be a type of artificial intelligence model designed to understand and generate natural-language input.

### TECHNICAL FIELD

The present disclosure relates to systems and methods for creating transfer messages based on unstructured data.

### BACKGROUND

At present, there are numerous requisite steps between declaring a desire to execute a data transfer and the actual execution of the data transfer. For example, a user may declare, during a voice call, teleconferencing session, or text chat, that he wishes to transfer a certain amount of data from one account to another account. In some instances, for example, the user may declare an intent to transfer data from an account associated with the user to an account associated with the other party to the communication. In some other instances, for example, the user may declare an intent to transfer data from an account associated with the user to an account associated with a third party.

At present, however, in order to effect this transfer, the user must take certain steps which may be onerous, time-consuming, and error-prone, such as navigating to an appropriate application, remembering one's login and password information, obtaining and correctly entering receiving party information, typing words and/or series of numbers with a high level of accuracy, and properly entering these words and numbers into various fields on a screen. In some cases where the user lacks computer-literacy, the user may be required to travel to another physical location to effect the transfer.

Accordingly, the present requirements for effecting a desired data transfer may be time-consuming and onerous. The present requirements may further be discriminatory and lack accessibility, especially to vulnerable social groups, such as older users who lack familiarity with computers, the illiterate, those of low intellectual capability, and those with attention deficit/hyperactivity disorder (ADHD) and/or avolition.

Improvements to the field are desired.

### BRIEF DESCRIPTION OF THE DRAWINGS

Reference will now be made, by way of example, to the accompanying drawings which show example embodiments of the present application and in which:

FIG. 1 is a schematic diagram illustrating an operating environment of an example embodiment;

FIG. 2 is a high-level schematic diagram of an example computing device;

FIG. 3 is a schematic block diagram showing a simplified organization of software components stored in memory of the example computing device of FIG. 2A;

FIG. 4 illustrates a flowchart of an example method for sending a transfer message based on unstructured text data, in accordance with embodiments of the present disclosure;

FIG. 5 illustrates an example cloud platform, in accordance with embodiments of the present disclosure.

### DETAILED DESCRIPTION

In accordance with one aspect of the present disclosure, there is provided a computer system for sending a transfer message based on unstructured text data. The computer system comprises a processor, a communications module coupled to the processor, a storage module coupled to the processor, and a memory coupled to the processor. The memory stores instructions that, when executed, configure the processor to: receive unstructured text data associated with an account; based on the unstructured text data, identify an intent to transfer data; send the unstructured text data to a Large Language Model (LLM) via a first prompt engine and an LLM Application Programming Interface (API); receive first LLM output data from the LLM; and send a transfer message based on the first LLM output data.

In some implementations, the transfer message is formatted to a standard and includes at least a plurality of data elements, the at least the plurality of data elements including a first data element configured to store a primary account number, a second data element configured to store a recipient account number, and a third data element configured to store a transfer amount.

In some implementations, the storage module stores account data in connection with the account, and generating the transfer message includes populating at least one data element of the plurality of data elements based on the account data.

In some implementations, the unstructured text data has been converted, using a speech recognition module, from an audio stream of data, the audio stream of data being associated with the account.

In some implementations, the audio stream of data represents a voice call.

In some implementations, identifying the intent to transfer data includes sending, via a second prompt engine and the LLM API, the unstructured text data to the LLM.

In some implementations, identifying the intent to transfer data includes performing a keyword search of the unstructured text data.

In some implementations, prior to sending the transfer message, the processor is further caused to send, to a client device associated with the account, a request for additional data, and to receive, from the client device, the additional data. The transfer message is generated further based on the additional data.

In some implementations, prior to sending the transfer message, the processor is further caused to send, to a client device associated with the account, a request for confirmation; and receive, from the client device, the confirmation.

In some implementations, the unstructured text data represents an invoice.

In some implementations, the unstructured text data represents a text chat.

In accordance with another aspect of the present disclosure, there is provided a computer-implemented method for converting unstructured data into a transfer message. The method comprises receiving unstructured text data associated with an account; based on the unstructured text data, identifying an intent to transfer data; sending the unstructured text data to a Large Language Model (LLM) via a first prompt engine and an LLM Application Programming Interface (API); receiving first LLM output data from the LLM; and sending a transfer message based on the first LLM output data.

In some implementations, the transfer message is formatted to a standard and includes at least a plurality of data elements, the at least the plurality of data elements including a first data element configured to store a primary account number, a second data element configured to store a recipient account number, and a third data element configured to store a transfer amount.

In some implementations, generating the transfer message includes populating at least one data element of the plurality of data elements based on account data.

In some implementations, the unstructured text data has been converted, using a speech recognition module, from an audio stream of data, the audio stream of data being associated with the account.

In some implementations, the audio stream of data represents a voice call.

In some implementations, identifying the intent to transfer data includes sending, via a second prompt engine and the LLM API, the unstructured text data to the LLM.

In some implementations, identifying the intent to transfer data includes performing a keyword search of the unstructured text data.

In some implementations, prior to sending the transfer message, the method further comprises: sending, to a client device associated with the account, a request for additional data; and receiving, from the client device, the additional data. The transfer message is generated further based on the additional data.

In accordance with another aspect of the present disclosure, there is provided a non-transitory computer readable storage medium comprising processor-executable instructions which, when executed, configure a processor to: receive unstructured text data associated with an account; based on the unstructured text data, identify an intent to transfer data; send the unstructured text data to a Large Language Model (LLM) via a first prompt engine and an LLM Application Programming Interface (API); receive first LLM output data from the LLM; and send a transfer message based on the first LLM output data.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

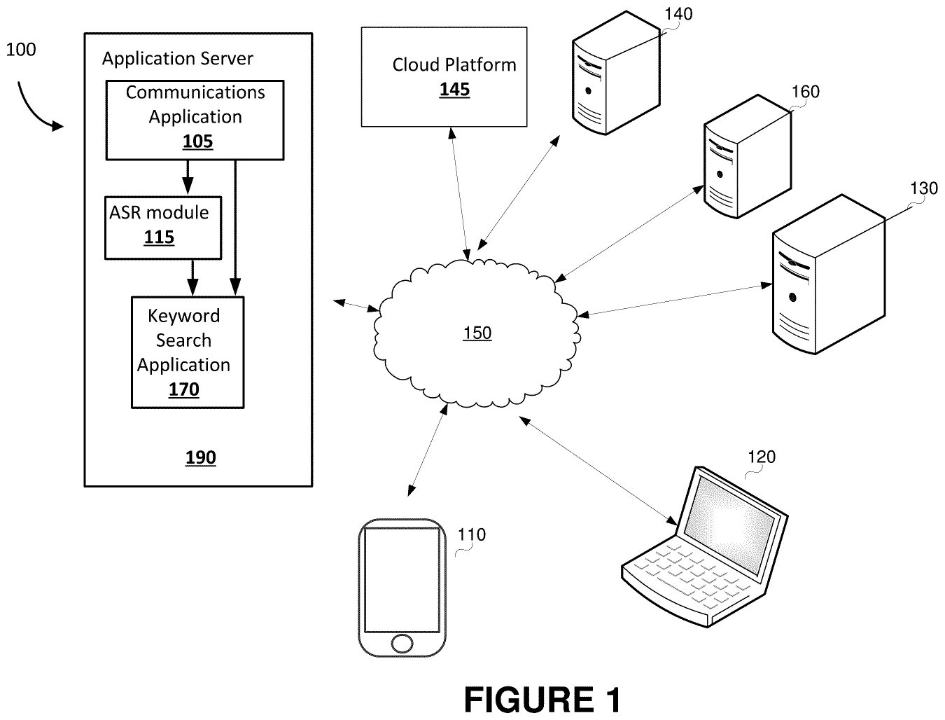

FIG. 1 is a block diagram illustrating an example operating environment 100 of an example embodiment, which may be used, for example, to perform one or more operations. As shown, the operating environment 100 includes a client device 110, a user device 120, a first server 130, a second server 140, a transfer rail server 160, an application server 190, and a cloud platform 145 coupled to one another through a network 150, which may include a public network such as the Internet and/or a private network.

In some embodiments, the first server 130 and the second server 140 may each maintain user accounts. A record in a database associated with and/or provided by the first server 130 or the second server 140 may be or may represent an account. The record may include, for example, documents and/or other data stored by or on behalf of a user. Such documents and/or data may include, for example, user preferences, digital identity data such as stored identity information or documentation, or other types of documents and/or data. In some implementations, the first server 130 may track, manage, maintain, and/or provide resources to a first system operator, and the second server 140 may track, manage, maintain, and/or provide resources to a second system operator. The resources may, for example, be computing resources, such as memory or processor cycles. By way of further example, the resources may include stored value, such as fiat currency, which may be represented in a database. For example, the first server 130 may be coupled to a first database, which may be provided in a first secure storage. The first secure storage may be provided internally within the first server 130 or externally. The first secure storage may, for example, be provided remotely from the first server 130. For example, the first secure storage may include one or more data centers. The data centers may, for example, store data with bank-grade security. Likewise, the second server 140 may be coupled to a second database, which may be provided in a second secure storage. The second secure storage may be provided internally within the second server 140 or externally. The second secure storage may, for example, be provided remotely from the second server 140. For example, the first secure storage may include one or more data centers. The data centers may, for example, store data with bank-grade security.

The first and/or second databases may include records associated with a plurality of entities. For example, the records may be for a plurality of accounts and at least some of the records may define or store resources. For example, the records may define a quantity of resources. For example, the first entity may be associated with an account having one or more records in the first database. The records may reflect a quantity of stored resources that are associated with the first entity. Such resources may include owned resources and/or borrowed resources. The first entity and the account may be or may be associated with a customer of a financial institution which operates or manages the first server 130. Likewise, the second entity may be associated with an account having one or more records in the second database. The records may reflect a quantity of stored resources that are associated with the second entity. Such resources may include owned resources and/or borrowed resources. The second entity and the account may be or may be associated with a customer of a financial institution which operates or manages the second server 140.

The first server 130 and the second server 140 may be operated by different entities. That is, the first server 130 may be associated with a first system operator and the second server 140 may be associated with a second system operator who is different than the first system operator. The second server 140 may be, for example, associated with a financial institution server that is associated with a different financial institution than the first server 130.

The first server 130 is configured to receive and complete data transfer requests. A data transfer may be a transfer of resources such as, for example, documents, tokens, computing resources and other stores of value. In some examples, a transfer may be a transfer of value or other resources from a first account to a second account. The first server 130 is configured to complete received data transfer requests according to one or more transfer methods (which may also be referred to herein as transfer protocols).

In some embodiments, the first server may include one or more prompt engine modules. The one or more prompt engine modules may comprise a first prompt engine module and a second prompt engine module. The first prompt engine module may be configured to receive unstructured text data in connection with an intent to transfer data, and to generate, based on the received unstructured text data, first prompt output data configured to cause a large language model (LLM) to generate first LLM output data based on the unstructured text data. In some embodiments, the first server 130 may receive, via the first prompt engine module, unstructured text data from the applications server 190 and/or the second prompt engine module, and may generate first prompt output data based on the received unstructured text data. The first prompt output data may include, for example, a request to generate a transfer message, such as a standardized transfer message. The transfer message may include at least a plurality of elements. The at least a plurality of data elements may include a first data element configured to store a primary account number, a second data element configured to store a recipient account number, and a third data element configured to store a transfer amount.

In some embodiments, transfer message may be, for example, an International Standards Organization (ISO) 20022 transfer message.

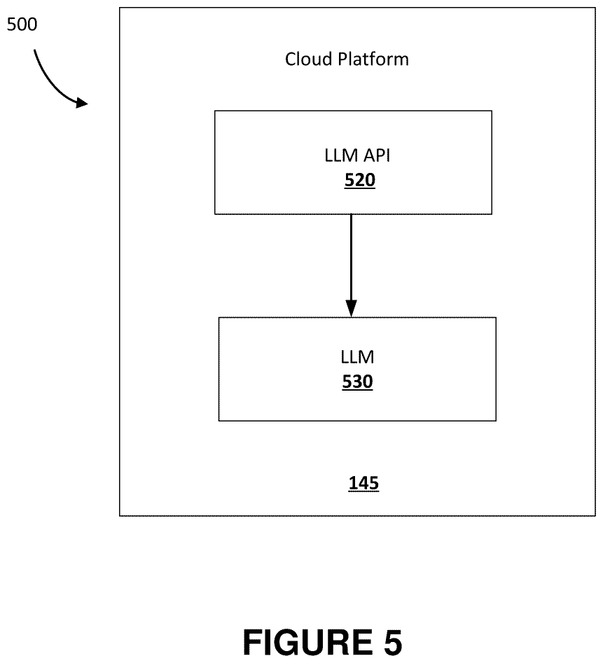

As will be further described in connection with FIG. 5, the one or more prompt engine modules may be configured to generate prompts based on received unstructured text data to cause an LLM to generate desired outputs. In some embodiments, the first prompt engine may be configured to generate first prompt output data to cause an LLM to generate first prompt output data comprising an ISO 20222 transfer message. In some embodiments, the second prompt engine module may be configured to generate second prompt output data to cause an LLM to generate second prompt output data providing an indication of an intent to transfer data.

As will be described in connection with FIG. 5, the first server 130 may be configured to provide, via the one or more prompt engine modules, first prompt output data to an LLM via an LLM Application Programming Interface (API).

In at least some embodiments, the transfer rail server 160 may be configured to facilitate a transfer from a first data record to a second data record according to a first transfer protocol. The first data record may be a data record maintained by the first server 130 and the second data record may be a data record maintained by a server associated with a different system operator than the first server 130 (e.g., such as the second server 140). The transfer rail server 160 may be a real-time transfer rail server 160 and may be configured to process the transfer in real-time or near real-time. The transfer rail server 160 may operate as an intermediary between the first server 130 and the second server 140.

The client device 110 and/or the user device 120 may take a variety of forms such as a smartphone, a tablet computer, a wearable computer such as a head-mounted display or smartwatch, a laptop or desktop computer, or a computing device of another type. The client device 110 and the user device 120 may also be referred to as electronic devices.

The client device 110 is a computing device that may be associated with a first entity, such as a user or client, having a record in a database associated with and/or provided by the first server 130. The record may be or may represent account data. The record may include data of various types and the nature of the data may depend upon the nature of the first server 130.

The user device 120 is also a computing device. In some implementations, the user device 120 may be associated with the first system operator, i.e., the user device 120 may be associated with a representative of the financial institution which operates or manages the first server 130. Alternatively, in some implementations, the user device 120 may be associated with a second entity, which may be a user or client having a record in a database associated with and/or provided by the second server 140.

The application server 190 may be a cloud platform, a web server, or the like. The application server 190 may comprise one or more separate servers. As shown, the application server 190 may include a communications application 105 to facilitate communication between the client device 110 and the user device 120 over the network 150 (FIG. 1). As further shown, the application server 190 may further include an automatic speech recognition (ASR) module 115 for converting audio data (from an audio call or a video call, for example) into text data, and a keyword search application 170.

The communications application 105 may provide for a communication session between the client device 110 and the user device 120, such as a chat session, an audio call, a video call, etc. In this way, the communications application 105 may provide for the display and and/or exchange of content between the client device 110 and the user device 120. The content may be, for example, speech, text, images, and/or digital documents, etc. The communications application 105 may record the displayed and/or exchanged content. In embodiments where the displayed and/or exchanged content comprises audio data, the communications application 105 may provide the audio data to the ASR module 115 for conversion to text data. The resulting text data may then be provided to the keyword search application 170 and/or to the first server 130. As a further example, where the displayed and/or exchanged content comprises image data such as a document, the communications application 105 may provide the image data to an Optical Character Recognition (OCR) module (not shown) to convert the image data to text data, which may then be likewise provided to the keyword search application 170 and/or to first server 130.

In some implementations, the communications application 105 may include a mobile application that includes a front-end which is installed on the client device 110 and the user device 120, and a back-end which is installed on the application server 190. As a further example, the communications application 105 may be a progressive web application (PWA) hosted by the application server 190 and made accessible via a browser on the client device 110 and the user device 120.

The cloud platform 145 is a collection of computing resources, including servers, managed by a cloud service provider. While FIG. 1 illustrates a single cloud platform in some embodiments, one or more cloud platforms 145 may be included in an operating environment 100 of the present disclosure.

The cloud platform 145 may comprise data centers located in various remote locations. world. Each data center may comprise multiple physical servers. The cloud platform 145 may host a plurality of digital assets such as websites, applications database, and files, for example. Examples of cloud platforms include Amazon Web Services (AWS), Microsoft Azure, and Google Cloud Platform (GCP), for example.

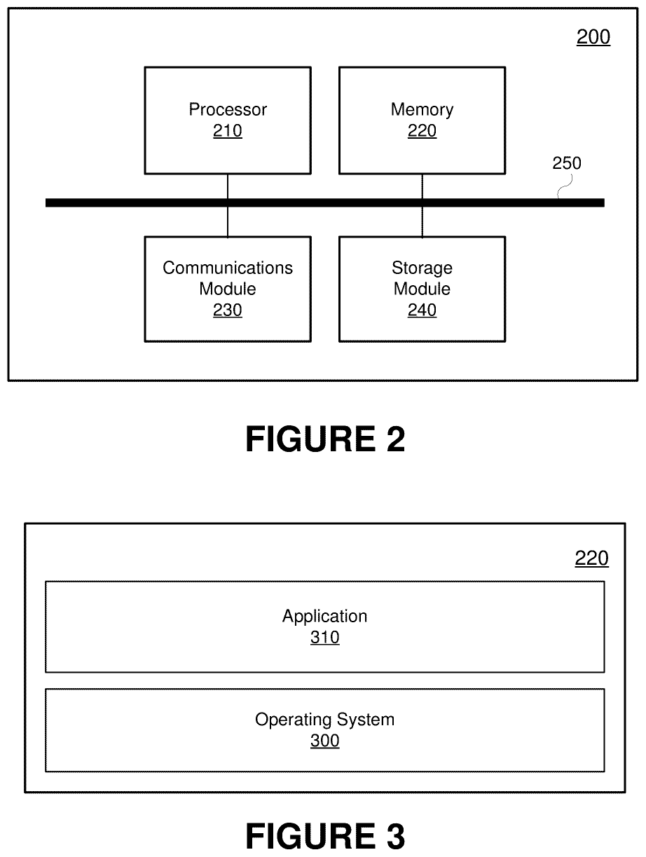

Referring now to FIG. 2, a high-level operation diagram of an example computer device 200 is shown. In some embodiments, the computer device 200 may be exemplary of the first server 130, the second server 140, the transfer rail server 160, the client device 110, the user device 120, and the application server 190 (FIG. 1).

The example computer device 200 includes a variety of modules. For example, as illustrated, the example computer device 200 may include a processor 210, a memory 220, a communications module 230, and/or a storage module 240. As illustrated, the foregoing example modules of the example computer device 200 are in communication over a bus 250.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computer device 200.

The communications module 230 allows the example computer device 200 to communicate with other computer or computing devices and/or various communications networks. For example, the communications module 230 may allow the example computer device 200 to send or receive communications signals. Communications signals may be sent or received according to one or more protocols or according to one or more standards. For example, the communications module 230 may allow the example computer device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 230 may allow the example computer device 200 to communicate using near-field communication (NFC), via Wi-Fi™, using Bluetooth™ or via some combination of one or more networks or protocols. In some embodiments, all or a portion of the communications module 230 may be integrated into a component of the example computer device 200. For example, the communications module may be integrated into communications circuitry. In some embodiments, the communications module 230 may be omitted such as, for example, if sending and receiving communications is not required in a particular application.

The storage module 240 allows the example computer device 200 to store and retrieve data. In some embodiments, the storage module 240 may be formed as a part of the memory 220 and/or may be used to access all or a portion of the memory 220. Additionally or alternatively, the storage module 240 may be used to store and retrieve data from persisted storage other than the persisted storage (if any) accessible via the memory 220. In some embodiments, the storage module 240 may be used to store and retrieve data in a database. A database may be stored in persisted storage. Additionally or alternatively, the storage module 240 may access data stored remotely such as, for example, as may be accessed using a local area network (LAN), wide area network (WAN), personal area network (PAN), and/or a storage area network (SAN). In some embodiments, the storage module 240 may access data stored remotely using the communications module 230. In some embodiments, the storage module 240 may be omitted and its function may be performed by the memory 220 and/or by the processor 210 in concert with the communications module 230 such as, for example, if data is stored remotely. The storage module may also be referred to as a data store and/or as a database.

Where the example computer device 200 functions as the first server 130 of FIG. 1, the storage module 240 may be the secure storage providing the database.

Software comprising instructions is executed by the processor 210 from a computer-readable medium. For example, software may be loaded into random-access memory from persistent storage of the memory 220. Additionally or alternatively, instructions may be executed by the processor 210 directly from read-only memory of the memory 220.

FIG. 3 depicts a simplified organization of software components stored in the memory 220 of the example computer device 200 (FIG. 2). As illustrated, these software components include an operating system 300 and application software 310.

The operating system 300 is software. The operating system 300 allows the application software 310 to access the processor 210 (FIG. 2), the memory 220, and the communications module 230 of the example computer device 200 (FIG. 2). The operating system 300 may be, for example, Google™ Android™, Apple™ iOS™, UNIX™, Linux™, Microsoft™ Windows™, Apple OSX™ or the like.

The application software 310 adapts the example computer device 200, in combination with the operating system 300, to operate as a device performing a particular function. For example, the applications 310 may cooperate with the operating system 300 to adapt a suitable embodiment of the example computer device 200 to operate as the first server 130, the second server 140, the transfer rail server 160, the client device 110, the user device 120, and/or the application server 190.

While a single application 310 is illustrated in FIG. 3, in operation the memory 220 may include more than one application 310 and different applications 310 may perform different operations. For example, in at least some embodiments in which the computer device 200 is functioning as the client device 110 and or the user device 120, the applications 310 may include a web browser, which may also be referred to as an Internet browser. In at least some such embodiments, the application server 190 may be or include a web server that may serve one or more of the interfaces described herein. The web server may cooperate with the web browser and may serve as an interface when the interface is requested through the web browser. The web browser may be configured to provide for communication with the application server 190. For example, the web browser may be configured to provide for text communication, and/or audio communication between the client device 110 and the application server 190. When the computer device 200 is functioning as the application server 190, as previously described, the applications 310 may include a communications application 105 (FIG. 1) to facilitate communication between the client device 110 and the user device 120 over the network 150 (FIG. 1), and/or an automatic speech recognition (ASR) module 115 (FIG. 1) for converting audio data (from an audio call or a video call, for example) into text data. When the computer device 200 is functioning as the application server 190, as previously described, the applications 310 may further include a keyword search application 170 (FIG. 1) and/or an OCR application (not shown) to convert image data to text data. When the computer device is functioning as the first server 130 (FIG. 1), the applications 310 may include one or more prompt engine modules, for example, a first prompt engine module and/or a second prompt engine module.

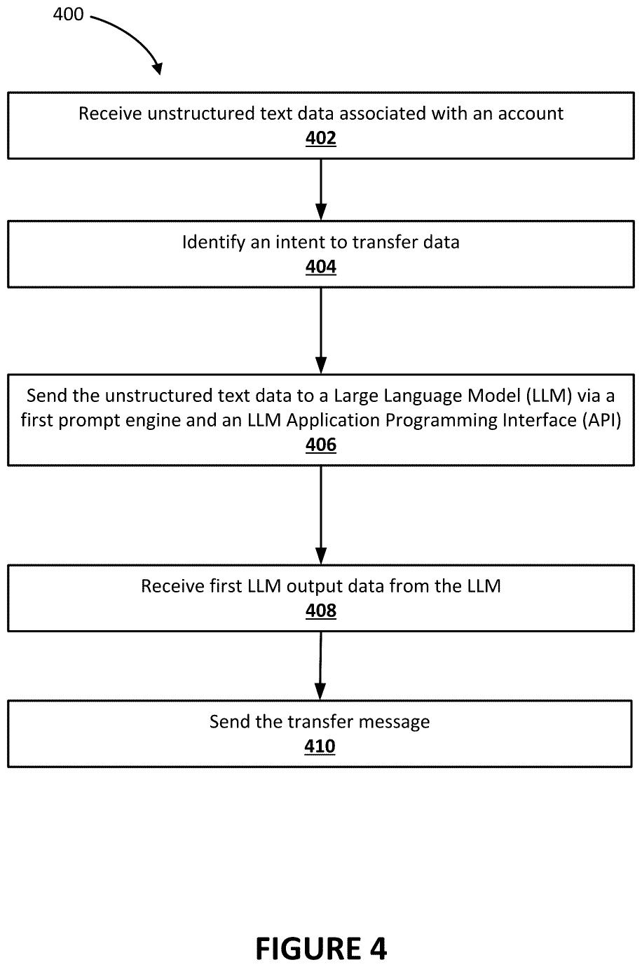

Reference is now made to FIG. 4, which illustrates a flowchart of an example method 400 for generating a transfer message based on unstructured text data, in accordance with embodiments of the present disclosure. FIG. 4 shows operations performed by a computing system, such as the first server 130. For example, in at least some implementations, computer-executable instructions stored in memory associated with the computing system may configure the computing system to perform the operations of the method 400 or a portion thereof. By way of example, the computer-executable instructions may cause a processor associated with the computing system to perform the method 400 or a portion of the method 400.

The computing system performing the method 400 may cooperate with other computing systems using a communications module 230 (FIG. 2). The communications module 230 (FIG. 2) may be or include a hardware communications module. By way of example, with reference to FIG. 1, the first server 130 may communicate with one or more of the second server 140, the client device 110, the user device 120, the transfer rail server 160, the application server 190, and/or the cloud platform 145, in order to perform the method 500 or a variation thereof.

At the operation 402, the system receiving unstructured text data associated with an account.

The unstructured text data may be or may represent, for example, an invoice. The unstructured text data may be, for example, a text transcript of a voice call. The unstructured text data may be, or may represent, for example, a text transcript of a teleconference session. The unstructured text data may be, or may represent, for example, a transcript of a text chat.

With reference again to FIG. 1, in some embodiments, the unstructured text data may be received by the first server 130 via the application server 190. In some such embodiments, the unstructured text data may represent a transcript of a text chat, a transcript of a voice call, and/or a transcript of a teleconferencing session between a first entity associated with both the account and the client device 110 and an operator of the user device 120. The first entity may be a customer of a financial institution which operates or manages the first server 130. The operator of the user terminal may be a representative of the financial institution which operates or manages the first server 130. Alternatively, the operator of the user terminal may be a second entity who is a customer of a financial institution which operates or manages the second server 140.

As previously noted, the first entity may be associated with an account having one or more records in the database of the first server 130. The records may reflect a quantity of stored resources that are associated with the entity. Such resources may include owned resources and/or borrowed resources. As also noted, the second entity may be associated with an account having one or more records in the database of the second server 140. The records may reflect a quantity of stored resources that are associated with the entity. Such resources may include owned resources and/or borrowed resources.

In some embodiments, the unstructured text data has been converted, using a speech recognition module, from an audio stream of data, the audio stream of data being associated with the account. In some embodiments, the speech recognition module may be the ASR module 115 (FIG. 1). In some embodiments, the audio stream of data may represent a voice call associated with communication between the client device and the user terminal.

Returning to FIG. 4, after the operation 402, the operation 404 is next.

At the operation 404, based on the unstructured text data, the system identifies an intent to transfer data.

In some embodiments, an indication of an identification to transfer data is received by the system together with the unstructured text data. For example, with reference again to FIG. 1, in some embodiments, the keyword search application 170 may be configured to search within the unstructured text data for certain words or phrases indicating an intent to transfer data. For example, prior to providing the unstructured text data to the first server 130, the application server 190 may be configured such that the keyword search application 170 searches the unstructured text data for words or phrases indicating an intent to transfer data. For example, the keyword search application 170 may search for phrases such as “want to pay”, “would like to pay”, etc. Where the certain words or phrases are identified by the keyword search application 170, the system may identify an intent to transfer data. In such embodiments, an indication of an identification to transfer data may be received, by the first server 130, together with the unstructured text data.

Alternatively, in some embodiments, subsequent to receiving the unstructured text data, the first server 130 may be configured to provide the unstructured text data to the second prompt engine module. As noted, the second prompt engine module may be configured to receive the unstructured text data and to prompt an LLM, via an LLM API, to identify, based on the received unstructured text data, an intent to transfer data.

Reference is now made to FIG. 5, which illustrates example cloud platform 145 hosting an LLM API 520 and an LLM 530. As noted, the cloud platform 145 is a collection of computing resources, including servers, managed by a cloud service provider. While FIG. 5 illustrates a single cloud platform hosting both the LLM API 520 and the LLM 530, in some embodiments, the LLM API 520 and the LLM 530 may be hosted my separate cloud platforms. As noted, the cloud platform 145 may comprise data centers located in various remote locations, and each data center may comprise multiple physical servers.

The LLM 530 is a type of artificial intelligence (AI) model designed to understand and generate natural-language input, including human-like text. The LLM 530 may be trained on huge datasets containing a wide range of text from sources such as the internet, books, articles, and other sources to learn the patterns, structures, and nuances of language. In this way, an LLM may comprehend natural-language input, including human-like text, and generate appropriate responses.

The LLM 530 maybe configured to perform a variety of language-related tasks, such as text generation, translation, summarization, question answering, etc. In this way, the LLM 530 may generate coherent and contextually relevant responses to text prompts.

The LLM 530 may be, for example, one of the OpenAPI™ Generative Pre-trained Transformer (GPT) series, such as GPT-1, GPT-2, GPT-3, and GPT-4. Alternatively, the LLM 530 may be a Bidirectional Encoder Representations from Transformers (BERT), a Text-To-Text Transfer Transformer (T5), an XLNet™, Robustly Optimized BERT Approach (ROBERTa), or a Turing-Natural Language Generation (Turing-NLG).

The LLM API 520 is an interface configured to provide access to the LLM 530. For example, the LLM API 520 may receive Hypertext Transfer Protocol (HTTP) requests comprising prompt output data from the one or more prompt engine modules of the first server 130. The LLM API 520 may then provide the prompt output data to the LLM 530 to in order to obtain LLM output data, which may then be provided to the first server 130 (FIG. 1).

In some embodiments, LLM output data may be or include an identification of an intent to transfer data. In some embodiments, the LLM output data may be or include a transfer message. The transfer message may be formatted to a standard and may include at least a plurality of data elements, the at least the plurality of data elements including a first data element configured to store a primary account number, a second data element configured to store a recipient account number, and a third data element configured to store a transfer amount. The transfer message may be, for example, an ISO 20022 transfer message.

The LLM API 520 may be, for example, an OpenAPI™ GPT API, a Google™ Cloud Natural Language API, a Microsoft Azure™ Cognitive Services API, or a Hugging Face™ Transformers API, for example.

Returning again to FIG. 4, after the operation 404, the operation 406 is next.

At the operation 406, subsequent to identifying an intent to transfer data, the system sends the unstructured text data to an LLM via a first prompt engine module and an LLM API.

For example, with reference again to FIG. 5, the system may generate, using the first prompt engine module, first prompt output data, and may provide the first prompt output data to the LLM API 520. The LLM API 520 may then provide the first prompt output data to the LLM 530, which may then generate a transfer message based on the first prompt output data.

Returning again to FIG. 4, after the operation 406, the operation 408 is next.

At the operation 408, the system receives first LLM output data from the LLM. In some embodiments, the first LLM output data may be a transfer message. The transfer message may be formatted to a standard and may include at least a plurality of data elements, the at least the plurality of data elements including a first data element configured to store a primary account number, a second data element configured to store a recipient account number, and a third data element configured to store a transfer amount. The transfer message may be, for example, an ISO 2002 transfer message.

At the operation 410, the system sends the transfer message.

In some embodiments, prior to sending the transfer message, the system may identify a requirement for additional data. For example, as noted, a transfer message may include at least a plurality of elements. The at least a plurality of data elements may include a first data element configured to store a primary account number, a second data element configured to store a recipient account number, and a third data element configured to store a transfer amount. In some embodiments, the system may generate a transfer message by populating the LLM output data with additional data. The additional data may be, for example, one or more of a primary account number, a recipient account number, and a transfer amount, for example. In some such embodiments, prior to sending the transfer message, the system may send, to a client device associated with the account, a request for additional data. The system may then receive, from the client device, the additional data. In this way, the system may generate the transfer message based on the additional data.

In some embodiments, prior to sending the transfer message, the system may send, to a client device associated with the account, a request for confirmation. The request for confirmation may include a request for confirmation of one or more of the primary account number, a recipient account number, and a transfer amount, for example. The request for confirmation may include, for example, a request for a confirmation of a time and date to be associated with sending the transfer request. The system may then receive, form the client device, the confirmation.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

1. A computer system for sending a transfer message based on unstructured text data, the computer system comprising:
a processor;
a communications module coupled to the processor;
a storage module coupled to the processor; and
a memory coupled to the processor, the memory storing instructions that, when executed, configure the processor to:
receive unstructured text data associated with an account;
based on the unstructured text data, identify an intent to transfer data;
send the unstructured text data to a Large Language Model (LLM) via a first prompt engine and an LLM Application Programming Interface (API);
receive first LLM output data from the LLM; and
send the transfer message based on the first LLM output data.

2. The computer system of claim 1, wherein the transfer message is formatted to a standard and includes at least a plurality of data elements, the at least the plurality of data elements including a first data element configured to store a primary account number, a second data element configured to store a recipient account number, and a third data element configured to store a transfer amount.

3. The computer system of claim 2, wherein the storage module stores account data in connection with the account, and wherein generating the transfer message includes populating at least one data element of the plurality of data elements based on the account data.

4. The computer system of claim 1, wherein the unstructured text data has been converted, using a speech recognition module, from an audio stream of data, the audio stream of data being associated with the account.

5. The computer system of claim 4, wherein the audio stream of data represents a voice call.

6. The computer system of claim 1, wherein identifying the intent to transfer data includes sending, via a second prompt engine and the LLM API, the unstructured text data to the LLM.

7. The computer system of claim 1, wherein identifying the intent to transfer data includes performing a keyword search of the unstructured text data.

8. The computer system of claim 1, wherein prior to sending the transfer message, the processor is further caused to:
send, to a client device associated with the account, a request for additional data; and
receive, from the client device, the additional data,
wherein the transfer message is generated further based on the additional data.

9. The computer system of claim 1, wherein prior to sending the transfer message, the processor is further caused to:
send, to a client device associated with the account, a request for confirmation; and
receive, from the client device, the confirmation.

10. The computer system of claim 1, wherein the unstructured text data represents an invoice.

11. The computer system of claim 1, wherein the unstructured text data represents a text chat.

12. A computer-implemented method for converting unstructured text data into a transfer message, the method comprising:
receiving unstructured text data associated with an account;
based on the unstructured text data, identifying an intent to transfer data;
sending the unstructured text data to a Large Language Model (LLM) via a first prompt engine and an LLM Application Programming Interface (API);
receiving first LLM output data from the LLM; and
sending the transfer message based on the first LLM output data.

13. The computer-implemented method of claim 12, wherein the transfer message is formatted to a standard and includes at least a plurality of data elements, the at least the plurality of data elements including a first data element configured to store a primary account number, a second data element configured to store a recipient account number, and a third data element configured to store a transfer amount.

14. The computer-implemented method of claim 13, wherein generating the transfer message includes populating at least one data element of the plurality of data elements based on account data.

15. The computer-implemented method of claim 12, wherein the unstructured text data has been converted, using a speech recognition module, from an audio stream of data, the audio stream of data being associated with the account.

16. The computer-implemented method of claim 15, wherein the audio stream of data represents a voice call.

17. The computer-implemented method of claim 12, wherein identifying the intent to transfer data includes sending, via a second prompt engine and the LLM API, the unstructured text data to the LLM, wherein the LLM is a type of artificial intelligence model.

18. The computer-implemented method of claim 12, wherein identifying the intent to transfer data includes performing a keyword search of the unstructured text data.

19. The computer-implemented method of claim 12, wherein prior to sending the transfer message, the method further comprises:
sending, to a client device associated with the account, a request for additional data; and
receiving, from the client device, the additional data,
wherein the transfer message is generated further based on the additional data.

20. A non-transitory computer readable storage medium comprising processor-executable instructions which, when executed, configure a processor to:
receive unstructured text data associated with an account;
based on the unstructured text data, identify an intent to transfer data;
send the unstructured text data to a Large Language Model (LLM) via a first prompt engine and an LLM Application Programming Interface (API);
receive first LLM output data from the LLM; and
send the transfer message based on the first LLM output data.
